(19) United States
(12) Patent Application Publication
(10) Pub. No.: US 2026/0186885 A1
(43) Pub. Date: Jul. 2, 2026

(54) DETECTING PERFORMANCE ANOMALIES AFFECTING PRODUCTION WORKLOADS

(71) Applicant: Microsoft Technology Licensing, LLC, REDMOND, WA (US)

(72) Inventors: Yasitha Shehan Liyanage WARAHENA LIYANAGE, Chicago, IL (US); Varun RAMESH, Bellingham, WA (US); Steven Brady ZUEHLSDORFF, Issaquah, WA (US); Ken HSIEH, Kirkland, WA (US); Murali Mohan CHINTALAPATI, Bellevue, WA (US)

(21) Appl. No.: 19/006,453

(22) Filed: Dec. 31, 2024

(51) Int. Cl. G06F 11/07

(52) U.S. Cl. CPC G06F 11/079; G06F 11/0709; G06F 11/0769

(57) ABSTRACT

Methods, apparatuses, and products for detecting performance anomalies affecting production workloads, including: receiving one or more performance signals associated with one or more production workloads that are executing in a production environment that utilizes one or more services provided by a distributed system; detecting that the one or more performance signals, when compared to a historical performance level associated with the one or more production workloads, represent anomalous performance in the production environment; identifying, from the one or more services, a service that is associated with the anomalous performance; and generating an alert that identifies the service that is associated with the anomalous performance.

### BACKGROUND

Distributed computing systems involve operations of a number of computing devices that interact with each other. Some distributed computing systems, which may be referred to as massively distributed computing systems, may employ a large number of components for different purposes, such as compute, networking, storage, or other purposes. These massively distributed computing systems may, in practice, include different environments for processing live production operations as opposed to staging or testing operations, where the different environments may be separated in some way. Such environments may be used by different entities, such as external customers, internal users of these systems, and/or system administrators.

Given the sheer scale of devices and applications and their importance to the entities involved, ensuring reliable performance is an important consideration. In the realm of performance management, identifying and resolving performance issues that impact customer experiences in live environments can be challenging. Known systems may rely on synthetic testing, which presents its own challenges, including high cost, as well as high implementation effort. Moreover, simulated testing may miss or fail to replicate real-world problems and may be tedious or costly to maintain at scale. Moreover, identification of performance issues may be delayed until a particular scale or intensity is reached, thereby delaying issue identification and resolution.

### SUMMARY

According to embodiments of the present disclosure, various methods, apparatus, and products for detecting performance anomalies affecting production workloads are described herein. In some aspects, receiving one or more performance signals associated with production workloads that are executing in a production environment using one or more services provided by a distributed system; detecting that the one or more performance signals, when compared to a historical performance level associated with the one or more production workloads, represent anomalous performance in the production environment; and identifying, based on the detection, a service, of the one or more services, that is associated with the anomalous performance in the production environment. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 a flow chart illustrating an example method for detecting performance anomalies affecting production workloads in accordance with some embodiments.

FIG. 2 sets forth a flow chart illustrating an example method for detecting performance anomalies affecting production workloads in accordance with some embodiments.

FIG. 3 sets forth a flow chart illustrating an example method for detecting performance anomalies affecting production workloads in accordance with some embodiments.

FIG. 4 sets forth a flow chart illustrating an example method for detecting performance anomalies affecting production workloads in accordance with some embodiments.

FIG. 5 sets forth a flow chart illustrating an example method for detecting performance anomalies affecting production workloads in accordance with some embodiments.

FIG. 6 sets forth a flow chart illustrating an example method for detecting performance anomalies affecting production workloads in accordance with some embodiments.

FIG. 7 sets forth a flow chart illustrating an example method for detecting performance anomalies affecting production workloads in accordance with some embodiments.

FIG. 8 sets forth a flow chart illustrating an example method for detecting performance anomalies affecting production workloads in accordance with some embodiments.

FIG. 9 sets forth an example of a computing device that may be used for some portion of detecting performance anomalies affecting production workloads in accordance with some embodiments.

FIG. 10 sets forth a block diagram of a cloud services provider service architecture in accordance with some embodiments of the present disclosure.

### DESCRIPTION OF EMBODIMENTS

Massively distributed computing systems, such as cloud computing environments provided by a cloud service provider, execute a number of software applications in production environments that service real-world clients. Clients have performance expectations from these production environments, including expectations regarding latency associated with an operation, as well as performance expectations associated with a service provided by the cloud service provider.

A cloud service provider may monitor the performance of components (e.g., services, resources, applications) that are being executed in a production environment and detect performance anomalies, such as a performance degradation event. For example, a cloud service provider may monitor the performance of some component to identify a latency regression event. Latency regression can refer to the latency behavior of a service or other component degrading relative to an expected level. The expected level may be represented by, or calculated as, a historical latency level. The expected level may also be represented by a customer's expectation of service levels, which may be defined in a service-level agreement as, for example, a maximum latency that is not to be exceeded for that customer.

A cloud service provider may detect performance anomalies such as latency regressions

using various methods such as, for example, a quickest change detection algorithm designed to identify changes in performance data as quickly as possible after the change occurs. In some embodiments, the cloud service provider may determine that an anomaly has occurred before a threshold (such as a threshold defined in a service level agreement) has been met. Determining that the performance anomaly can include filtering out false positives, such as by comparing received performance data to false positive thresholds. The cloud service provider can define these false positive thresholds in ways that account for transient performance deviations for the service and/or noise from other operations.

In some embodiments, the cloud service provider can detect performance anomalies at an individual customer level. The cloud service provider can monitor performance for an individual customer's workloads and components to determine that an anomaly has occurred or is occurring with respect to that individual customer's production environment. For example, the cloud service provider may detect a latency regression with respect to a resource being used by the customer's workloads.

The cloud service provider can aggregate distinct performance signals as part of detecting a performance anomaly. Aggregation of performance signals can be performed using various techniques (e.g., sensor fusion) that may amplify otherwise less prominent signals into a performance signal that more strongly represents the likelihood, in the aggregate, that a performance anomaly is occurring. Furthermore, these aggregation techniques can smooth out noise from unrelated executions.

In some implementations, the cloud service provider can sample performance data from different environments or execution instances that are associated with the performance signal. The sampled performance data may be associated with various performance ranges (e.g., anomalous and/or normal performance ranges) and may be used to obtain a more comprehensive execution analysis associated with the components that have likely contributed to the performance anomaly. The execution analysis can represent, for example, an end-to-end execution behavior for a variety of hardware components, software components, or other components that are involved in performing some task.

The cloud service provider can use the execution analysis to identify a component whose execution is contributing to the occurrence of the performance anomaly. The cloud service provider can then generate notifications, such as alerts or incident tickets, where the notifications are reported to various entities and describe the performance anomaly and associated components.

As a result of the cloud service provider offering the abovementioned performance anomaly detection and alerting systems, significant improvements in performance anomaly detection in production environments can be achieved. By applying real, live production environment data to performance anomaly detection, the cloud service provider can identify performance degradations or anomalies in near real-time and based on actual client impact. Likewise, the knowledge that the performance anomaly was detected using production data, rather than based on simulations, may increase the likelihood an issue will be investigated and may even allow for actual issues to be prioritized over simulated issues. The cloud service provider's use of techniques such as quickest change detection and sensor fusion can result in quicker detection of performance problems, and better filtering of noise from the performance signal fluctuations to provide for more accurate detection of performance problems.

By detecting performance anomalies more rapidly and accurately, downtime may be reduced and the time spent triaging non-issues may also be reduced, which can improve the customer experience in ways that can provide a competitive advantage and ultimately contribute to greater adoption of the cloud service provider's services. Detecting performance anomalies more rapidly and accurately can also reduce the likelihood that a service level agreement is violated, and any punitive actions (e.g., lost revenue) in the service level agreement are triggered.

Moreover, by using the above-described anomaly detection systems, the cloud service provider can deliver further cost savings. For instance, these systems can lead to a reduced reliance on costly synthetic monitoring and testing, which can involve introducing and monitoring simulated workloads that simulate production workloads. By using live production workloads for anomaly detection, the need for synthetic monitoring is reduced or obviated. Less synthetic monitoring may also result in a more scalable system, as the need for additional resources to support additional simulated workloads for monitoring/testing purposes is reduced.

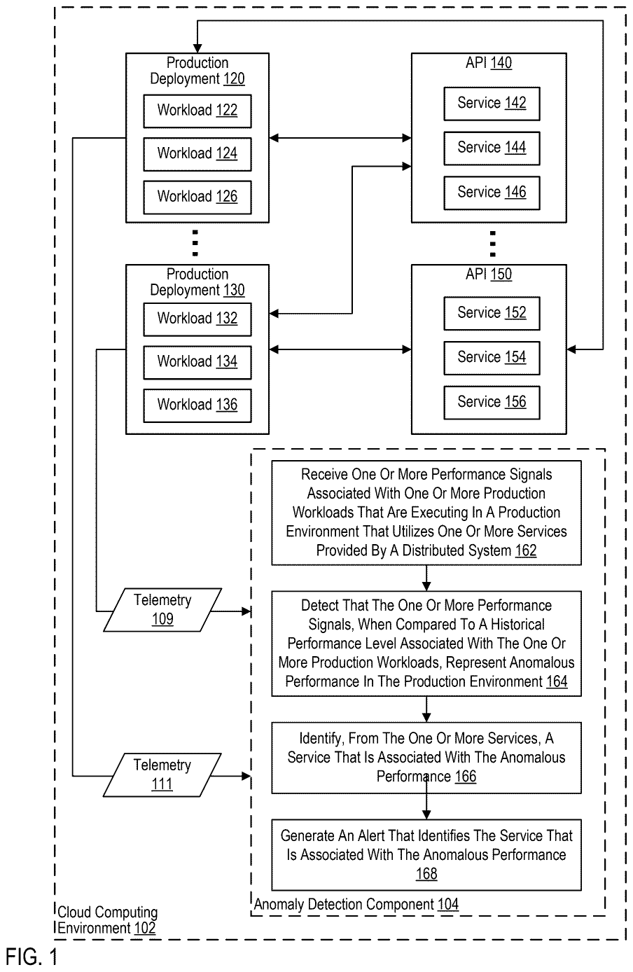

For further explanation, FIG. 1 sets forth a flow chart illustrating an example method for detecting performance anomalies affecting production workloads in accordance with some embodiments. The method of FIG. 1 may be performed, for example, in a system such as cloud computing environment 102 of FIG. 1 or in another computing system or computing environment as can be appreciated. For example, in some embodiments the method of FIG. 1 may be performed by one or more system-level modules that are utilized by the cloud service provider to monitoring the performance of various resources that are being provided by the cloud service provider.

The method of FIG. 1 includes receiving 162 one or more performance signals associated with one or more production workloads executing in a production environment that utilizes one or more services provided by a distributed system. As described herein, a distributed system can represent any configuration of a number of computing devices in interaction with each other. In some cases, the distributed system may be a massively distributed system that includes a large number of hardware resources, software resources, and so on. As one example, the distributed system can be embodied as the collection of resources that are managed by a cloud service provider and used to provide various services offerings to cloud customers.

The example depicted in FIG. 1 includes a cloud computing environment 102, which can be the collection of resources that are managed by a cloud service provider and used to provide various services offerings to cloud customers. The cloud customers can be traditional customers that are external to the cloud service provider, or even internal customers that are part of the same organization that offers cloud computing environment 102. Where performance anomalies are detected, external as well as internal customers may be notified. In addition, administrators of one or more aspects of the cloud computing environment 102 may also receive alerts when anomalies are detected.

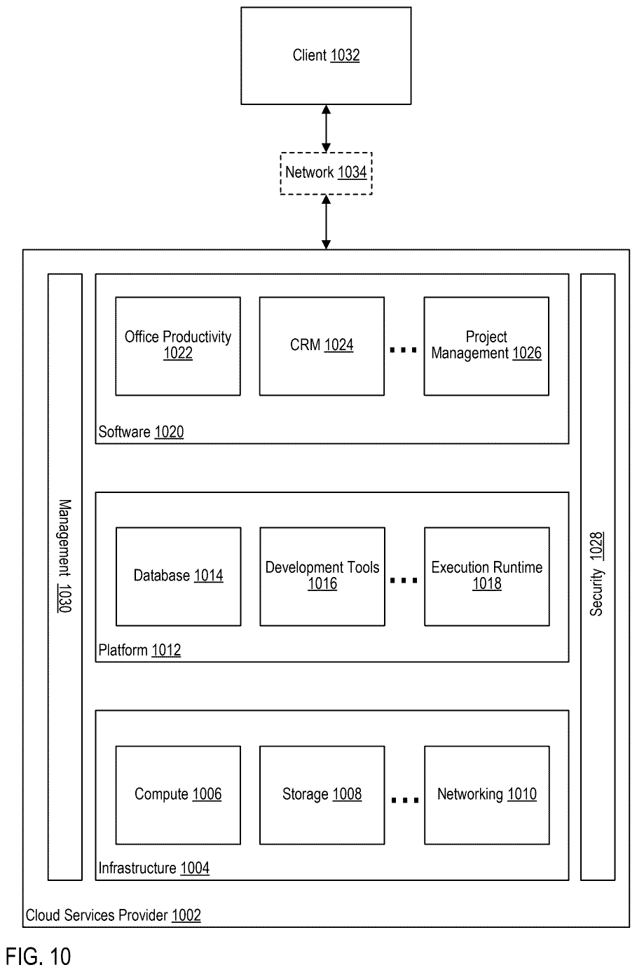

As shown in FIG. 1, cloud computing environment 102 includes production deployment 120 and production deployment 130. Production deployments 120, 130 can be embodied as a combination of hardware and software resources that are associated with a particular customer. In some embodiments, a particular customer may have multiple production deployments. For example, a customer's engineering team may have one production deployment 120, the same customer's finance team may have another production deployment 130, and so on. Each production deployment 120, 130 may be embodied as a cloud deployment that a particular customer may use for some purpose such as, for example, executing an application, storing data, obtaining one or more services, and so on. Each production deployment 120, 130 can therefore include any combination of the resources that are offered by a cloud service provider, including any combination of the resources described in greater detail below with reference to FIG. 10.

The example in FIG. 1 also includes application programming interfaces (APIs) 140, 150 that can be used to provide various services 142, 144, 146, 152, 154, 156 to a customer of the cloud service provider. As an example, a particular API 140 can provide a service 142 that offers database functionality to the production deployments 120, 130. The service 142 can take the form of an API endpoint, which can include the URL of a server or service, or be provided through a deployment and management service such as Azure Resource Manager. While two APIs are depicted in FIG. 1, it will be appreciated that cloud computing environment 102 may provide a much greater array of services in various ways including via APIs as well as by other means.

The cloud computing environment 102 of FIG. 1 can include an anomaly detection component 104. In some embodiments, the anomaly detection component 104 may include any combination of hardware and software that is configured to provide the functionality described herein. In some embodiments, the anomaly detection component 104 may be configured to receive telemetry data directly or indirectly from one or more production deployments 120, 130.

As shown in FIG. 1, the production deployments 120, 130 can send telemetry 109, 111 data to the anomaly detection component 104. The telemetry 109, 111 data can include values for various performance metrics associated with a production workload such as, for example, latency metrics for various tasks, uptime metrics, fault tolerance metrics, or the like. The telemetry 109, 111 data may be sent to the anomaly detection component 104 via one or more messages, written into one or more log files that are accessed by the anomaly detection component 104, or otherwise made available to the anomaly detection component 104.

Readers will appreciate that the performance of a customer's workload can vary over time. For example, in the case of a client-facing application, usage may be relatively low at night such that resources being used to deploy the client-facing application are sufficient to service the relatively lower load. By contrast, there may be usage spikes at the beginning of a work day, or during specific times of day or periods during the year when significant increases in load may be observed. Similarly, a media streaming platform may experience higher loads at night when usage is likely to be higher, thereby straining the ability of the resources that are provided by, for example cloud computing environment 102, to handle the incoming usage.

Readers will appreciate that customer deployments may be expected to perform in a reliable manner, where reliability may be defined in different ways. In some embodiments, reliability may be defined as an expected level of reliability. The expectation may be further defined by external measures such as a service level objective or service level agreement with the customer. Reliability may be determined, for example, based on latency, a number of errors, uptime, fault tolerance, satisfaction of a recovery time objective or a recovery point objective, degree of data recoverability in cases of failure, or by other means. Latency may be tracked, for example, as an average P50 latency or P99 latency, where a P50 latency level can indicate that 50% of operations were processed faster than the P50 latency level, whereas 50% took a longer time. Similarly, P99 can represent a 99th percentile latency, whereby 99% of operations were processed faster than the P99 latency level, and 1% took a longer time to complete.

In some cases, customers of the cloud computing environment 102 may report dissatisfaction with performance or reliability associated with execution of their workloads. In many of these cases, such reports may occur even where the perceived change in reliability or performance does not rise to a level where some defined threshold is violated, such as SLO/SLA, RPO/RTO, yet a customer may raise an incident ticket and request remediation. Accordingly, early detection of performance regressions before impacts to individual customers is an important consideration with respect to the disclosed systems and methods of detecting performance anomalies affecting production workloads.

It will be appreciated that the increased latency exhibited by one service or component may have indirect effects on the performance of a customer workload or even other customer workloads. In some cases, the customer workload may use another service or component whose performance depends in some way on the service that is exhibiting higher latency. In such cases, if the service is exhibiting higher than normal latency, such a performance anomaly may not cause customer impact on its own but may increase the likelihood of failures or other performance problems at the other service or component that is also involved in the customer workload's execution and whose performance depends in some way on the affected service. Similarly, customer dissatisfaction can result in cases where another unexpected issue occurs simultaneously, while the service is exhibiting higher latency, such as an issue with another component that is also used by the customer workload but is not otherwise dependent on performance of the service that exhibited the higher latency. Moreover, even if the performance of that customer workload is not noticeably impacted in the customer's view, a performance regression associated with that workload can have a cascading effect on other workloads of that customer or other customers or at other components such as another software application or another device in cloud computing environment 102 such that performance issues can stack up across a cloud environment such as cloud computing environment 102 that can feature a massive number (e.g., millions) of devices, software instances, users, connections, and other components. Accordingly, the systems and methods disclosed herein are configured to perform early detection of performance regressions before impacts to individual customers associated with the workload whose performance regressed, as well as impacts to other entities.

While the above discussion provides specific examples of customer workloads in production deployments that are serviced using one or more APIs offered by cloud computing environment 102, readers will appreciate that the systems and methods of detecting performance anomalies affecting production workloads disclosed herein can apply to many different configurations of a distributed system and/or to many other different types of distributed systems or to any system where multiple software-enabled devices are interacting in some configuration. Examples of distributed systems as contemplated herein can include any cloud computing systems in any configuration such as public cloud, private cloud, hybrid cloud, multi-cloud, various combinations of cloud-based and on-premise resources, or other cloud configurations or some combination of the configurations described above. Other examples of distributed systems can include telecommunications networks, autonomous vehicle fleets, or the like. Readers will appreciate that the systems and methods of detecting performance anomalies affecting production workloads disclosed herein are not limited in scope to performance anomalies associated with workloads accessing APIs that provide services and that the description of the use of API services in a cloud environment is purely exemplary.

The disclosed systems and methods can be applied in several other contexts. For example, cloud computing environment 102 may provide other features or functionality. Cloud computing environment 102 may provide servers for storage or compute purposes, virtual private networks, containerization services, code build/test facilities, machine learning or artificial intelligence models, data lakes or data analytics facilities, security tools, compliance or governance features, serverless computing, or other features. Some such features may be provided as services exposed by APIs, whereas others may be provided in other ways. Regardless of the particular configuration of a distributed system or the services provided, the disclosed systems and methods can enable detection of performance anomalies in production workloads.

Referring back to FIG. 1, the method depicted in FIG. 1 includes receiving 162 one or more performance signals associated with one or more production workloads executing in a production environment that utilizes one or more services provided by a distributed system. Receiving 162 one or more performance signals associated with production workloads can be carried out, for example, by the anomaly detection component 104 receiving telemetry 109, 111 data from any of the production deployments 120, 130. The anomaly detection component 104 can request telemetry 109, 111 data at intervals which may be predefined. Alternatively, the production deployments 120, 130 can be configured to send telemetry 109, 111 data to the anomaly detection component 104. The telemetry 109, 111 data may be associated with various components in the production deployments such as, for example, one or more processes that are executing, one or more cloud resources that are included in the production deployment, user activity that is occurring in the production deployment, and so on.

In some embodiments, the telemetry data that is received 162 can include latency data for one or more workloads executing in one or more of the production deployments 120, 130. The latency data can indicate latency values for processes that are executing with respect to the workload and may be expressed in units of time. For example, the latency data can indicate latency values associated with the creation of a virtual machine for executing a workload. Readers will appreciate that the latency values may indicate an expected latency, or a latency that is unexpected, outside limits, or satisfying some threshold value (e.g., maximum latency threshold), where the threshold value may be defined in various ways, such as by a service level agreement with the customer.

It may further be appreciated that there may be deviations from expected latency values that do not meet a threshold. A deviation from an expected level for latency (also referred to as a latency regression) associated with a customer workload, such as an increase in latency, may be transient such that the increase in latency does not result in any noticeable change in performance of the customer workload. In other cases, the latency regression may or may not meet any defined threshold but may still result in a performance change. Such latency regressions may increase the likelihood of a customer-reported incident ticket being raised, or the likelihood of a slowdown that negatively affects performance of the workload, or the likelihood that other processes will be affected.

The method of FIG. 1 also includes detecting 164 that the one or more performance signals, when compared to a historical performance level associated with the one or more production workloads, represent anomalous performance in the production environment. Detecting 164 that the one or more performance signals, when compared to a historical performance level associated with the one or more production workloads, represent anomalous performance in a production environment can be carried out, for example, by comparing information contained in the performance signals to baseline information (e.g., historical data) that represents normal performance. Such a comparison may be performed by the anomaly detection component 104 in some embodiments. For example, the one or more performance signals that are received in the telemetry 109, 111 data may be compared to historical performance data for the customer workload. The historical performance data can include, for example, historical latency data associated with the customer workload. The historical latency data may be updated based on some schedule, upon the occurrence of some event, after a predetermined number of signals have been received, or in other ways. The historical latency data may include data relating to latency regression events that took place with respect to the customer workload. These latency regression events may be associated with a probability value, which may also be termed a prior probability value. Readers will appreciate that anomaly detection component 104 may use some amount of historical latency data as a baseline in determining the prior probability. The baseline may be determined using, for example, 90 days of historical latency data for the workload.

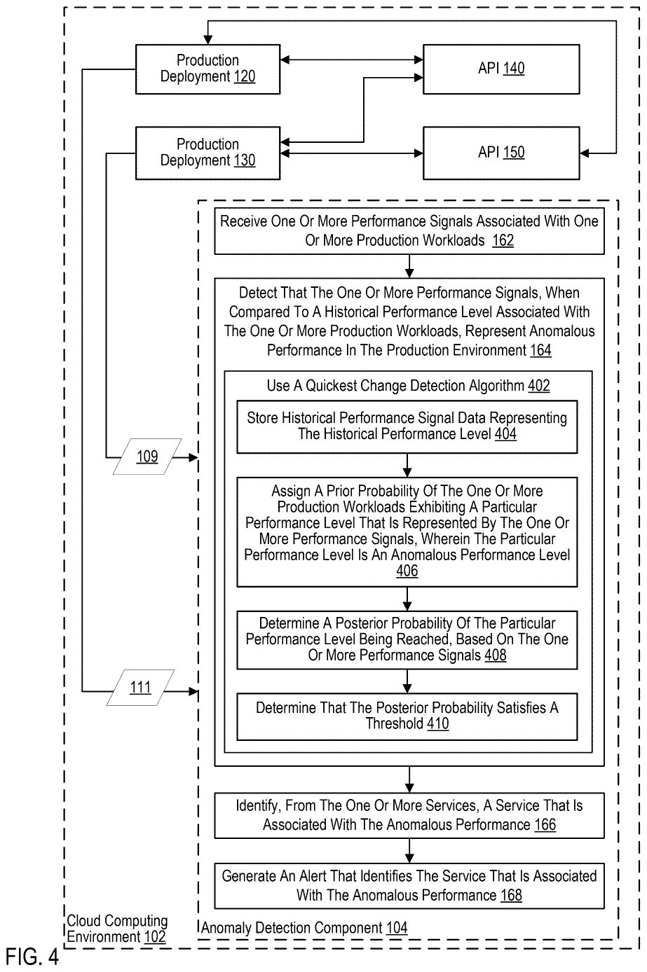

In some embodiments, the anomaly detection component 104 can determine or keep track of the posterior probability of an anomaly (e.g., a latency regression) occurring for a particular customer workload. The posterior probability can be determined by updating the prior probability of anomaly occurring with new information, such as the performance signals received via telemetry 109, 111 data. For example, the anomaly detection component 104 may be configured to use a quickest change detection algorithm to determine the posterior probability of a latency regression occurring for a customer workload, as described in further detail below with respect to FIG. 4.

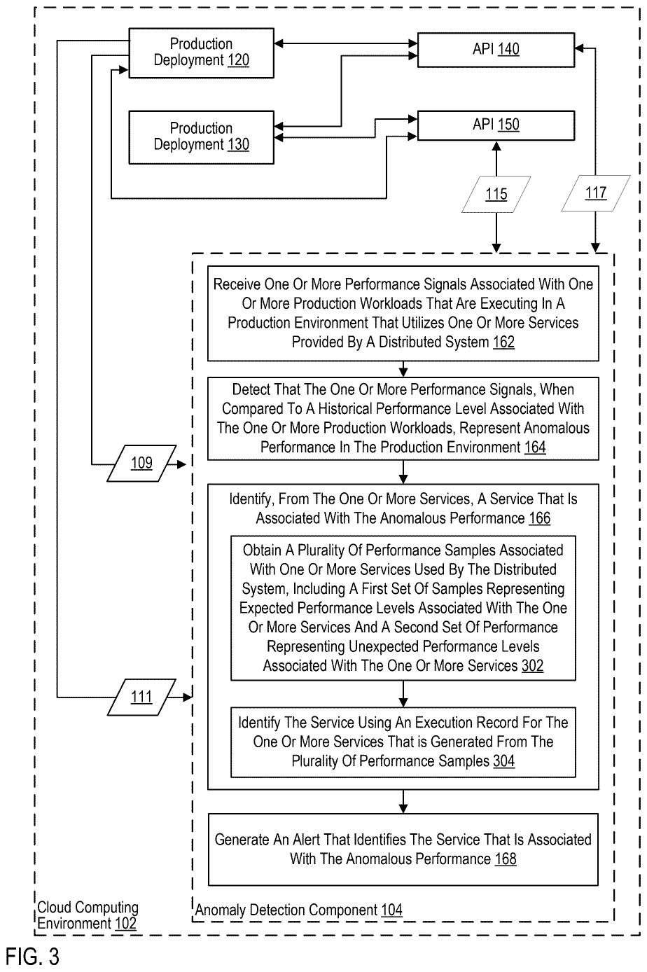

The method of FIG. 1 also includes identifying 166, from the one or more services, a service that is associated with the anomalous performance. In some embodiments, the anomaly detection component 104 aggregates a number of performance signals to create an aggregated performance signal. For example, a number of performance signals may be received from workloads 122, 124, 126, 132, 134, and 136. Some or all of these performance signals may be aggregated into an aggregated performance signal that indicates, for example, latency behavior as aggregated across these workloads. For workloads whose aggregated performance signal satisfies some aggregated performance degradation threshold, anomaly detection component 104 can sample performance data from APIs or other services being provided to the affected workloads, as described in further detail below with respect to FIG. 3. The sampled performance data from the APIs can be used to generate end-to-end execution records for the APIs or related components in order to identify a critical path latency that highlights the specific services that may be experiencing diminished performance that is leading to the performance regression being indicated in telemetry received from the affected workloads. In other embodiments, identifying 166 a service that is associated with the anomalous performance may be carried out in other ways. For example, metadata may be incorporated into the performance signals at the time that they are generated where the metadata includes information identifying a service that the performance signal relates to, or the performance signal may be associated with the service that the performance signal relates to in some other way.

The method of FIG. 1 also includes generating 168 an alert that identifies the service that is associated with the anomalous performance. Generating 168 an alert that identifies the service that is associated with the anomalous performance may be carried out, for example, by sending a message to one or more support teams, individuals, or other entity that can investigate or remediate the performance anomaly. Alternatively, generating 168 an alert that identifies the service that is associated with the anomalous performance may be carried out by presenting information describing the alert in a user interface (e.g., an issue dashboard) that is accessible to internal support teams associated with the cloud service provider, one or more administrators or users of the production deployment, or other approved user. Generating 168 an alert that identifies the service that is associated with the anomalous performance may be carried out as explained in greater detail below.

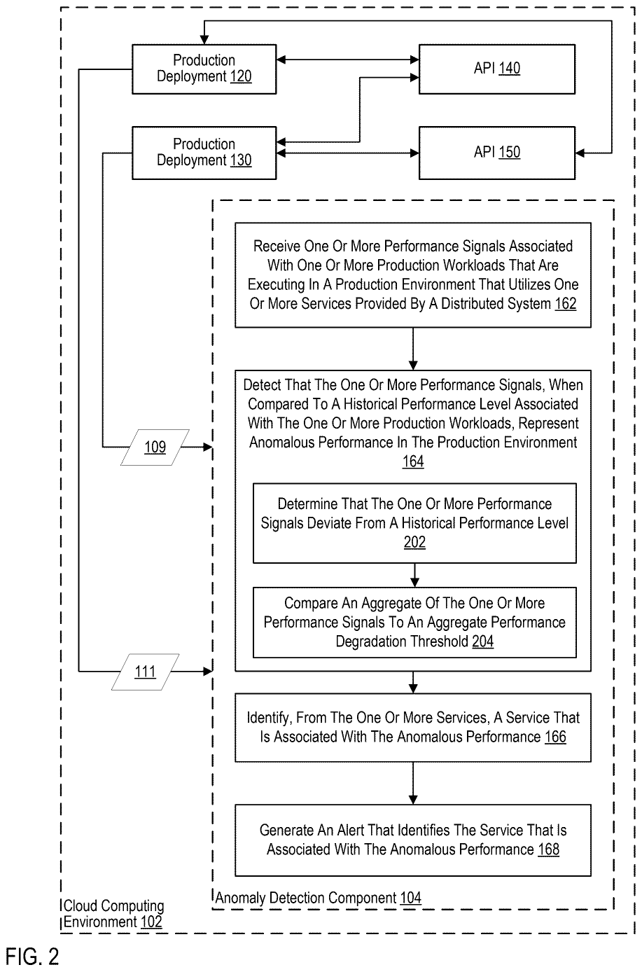

For further explanation, FIG. 2 sets forth a flow chart illustrating an example method for detecting performance anomalies affecting production workloads in accordance with some embodiments. The example method of FIG. 2 includes determining 202 that the one or more performance signals deviate from a respective historical performance level. As described above with respect to FIG. 1, anomaly detection component 104 can compare a received performance signal to a respective historical performance level to determine whether an individual performance signal is indicative of a performance regression (e.g., a latency regression). In some embodiments, at an individual customer level, the anomaly detection component 104 determines a posterior probability of a performance regression occurring relative to given percentile values for performance with respect to one or more APIs that the customer workload is using. The percentile values may represent a historical performance level for the customer workload. In one example embodiment, the performance values may be generally applicable for different executions of the customer workload. In another example, the performance values may be specific to the customer workload's executions when using a specific API or specific service(s). In some embodiments, when the posterior probability satisfies some threshold value, anomaly detection component 104 can declare that the customer's workload is experiencing a performance anomaly. The example depicted in FIG. 2 illustrates an embodiment where determining 202 that the one or more performance signals deviate from a respective historical performance level is carried out as part of detecting 164 that the one or more performance signals, when compared to a historical performance level associated with the one or more production workloads, represent anomalous performance in the production environment.

The example method of FIG. 2 also includes comparing 204, based on a determination that the one or more performance signals deviate from the respective historical performance level, an aggregate of the one or more performance signals to the performance degradation threshold. In this example, the performance degradation threshold is an aggregate performance degradation threshold. As described above, anomaly detection component 104 can aggregate different individual customer level performance signals into an aggregate performance signal. The aggregate performance signal can be compared to an aggregate performance signal threshold such that, if the aggregate performance signal threshold is met, anomaly detection component 104 can take further actions such as obtaining sample data from one or more workloads in order to identify specific services that may be the source of the anomaly, as described further with respect to FIG. 3 below. The example depicted in FIG. 2 illustrates an embodiment where comparing 204 an aggregate of the one or more performance signals to the performance degradation threshold is carried out as part of detecting 164 that the one or more performance signals, when compared to a historical performance level associated with the one or more production workloads, represent anomalous performance in the production environment.

For further explanation, FIG. 3 sets forth a flow chart illustrating an example method for detecting performance anomalies affecting production workloads in accordance with some embodiments. The example method of FIG. 3 includes obtaining 302 a plurality of performance samples associated with one or more services provided by the distributed system. The plurality of performance samples can include a first set of samples representing expected performance levels associated with the one or more services and a second set of performance representing unexpected performance levels associated with the one or more services. The performance sample data can indicate, for example, latency data associated with a service or set of services. Obtaining 302 the plurality of performance samples described here may be carried out, for example, by retrieving the performance samples from a repository that includes performance data that has been classified as either anomalous or non-anomalous (i.e., expected performance). In fact, such data may even be updated regularly as the telemetry 115, 117 data is received and processed, such that performance data that is included in telemetry 115, 117 data can be characterized as being either representative of expected performance levels or representative of unexpected performance levels. Once the telemetry 115, 117 data has been characterized, performance data from the telemetry 115, 117 data can be incorporated into the appropriate sample set, such that each sample set can stay up-to-date. Once obtained 302, the first set of samples representing expected performance levels and the second set of performance representing unexpected performance levels can be utilized as part of detecting 164 that the one or more performance signals, when compared to a historical performance level associated with the one or more production workloads, represent anomalous performance in the production environment, determining 202 that the one or more performance signals deviate from a respective historical performance level, or even identifying 166 a service that is associated with the anomalous performance.

In some embodiments, obtaining 302 a plurality of performance samples associated with one or more services provided by the distributed system can be in response to a determination that the aggregate performance signal satisfies an aggregate performance signal threshold. The anomaly detection component 104 may determine, from the APIs or other facilities of cloud computing environment 102 that are providing services (e.g., API services) or other features to production deployments 120, 130, the APIs or features that are being used by workloads that exhibited performance anomalies. Performance signals from these workloads can be aggregated to determine that a performance anomaly event is occurring with respect to those workloads. Based on a determination that the performance anomaly event is occurring, the anomaly detection component 104 may obtain 302 a plurality of performance samples associated with one or more services provided by the distributed system so that the anomaly detection component 104 can look for the specific APIs, services, features, or facilities that workloads affected by latency regressions are using. In other embodiments, the anomaly detection component 104 may obtain 302 performance samples associated with the one or more services at different times that are unrelated to a performance anomaly determination.

In some embodiments, the anomaly detection component 104 can select samples from the

obtained telemetry 115, 117 data that are within some regression limit. For example, the anomaly detection component 104 can determine that the expected average end-to-end latency associated with workload 122 was 10 milliseconds, but that in a current latency regression event, the latency associated with workload 122 is 20 milliseconds. Based on this determination, the anomaly detection component 104 can get performance samples for different services in APIs 140, 150 that are associated with latencies in the 10 milliseconds to 20 milliseconds range. These performance samples may comprise a first set of samples representing expected performance levels and a second set of samples representing unexpected performance levels.

The example method of FIG. 3 also includes identifying 304 the service using an execution record for the one or more services that is generated from the plurality of performance samples. The anomaly detection component 104 can generate an execution record for one or more services that were associated with latencies in the 10 milliseconds to 20 milliseconds range. In some embodiments, the anomaly detection component 104 can feed the samples to an on-demand service that can generate execution records such as stack traces that depict an end-to-end service-level latency breakdown. The anomaly detection component 104 can use the generated execution record to identify a specific service that is likely responsible for the latency regression.

In some cases, the anomaly detection component 104 can identify a specific service that is responsible for the latency regression by identifying all the services a workload is using, reviewing service-level latency data for each one, and identifying the service that is contributing to the latency regression. However, in other cases, one service may be the apparent cause of the latency regression, but another underlying or related component such as another code path that may be the actual source of the latency regression or other performance issue. For such cases, the anomaly detection component 104 can be configured to review the execution record and identify a critical path of service executions that is contributing to the latency regression. For example, the critical path can indicate a first service that is directly used by the workload and likely associated with the latency regression, but can also show one or more other services that, while not directly servicing the workload, are interoperating with the first service in some way and are other possible candidates for being the service that is the main contributor to the latency regression. Additionally, the anomaly detection component 104 can identify other customers whose workloads use the impacted service (or similar services). The anomaly detection component 104 can proactively notify these other customers of performance regressions that may potentially affect their workloads even if their workloads have not currently exhibited performance regression.

For further explanation, FIG. 4 sets forth a flow chart illustrating an example method for detecting performance anomalies affecting production workloads in accordance with some embodiments. The example method of FIG. 4 includes detecting 402 that the one or more performance signals, when compared to a historical performance level associated with the one or more production workloads, represent anomalous performance using a quickest change detection algorithm. A quickest change detection algorithm can be employed to identify a change point at which some statistical property of a process changes. Various types of quickest change detection algorithms may be used such as Bayesian methods or non-Bayesian methods such as minimax or other methods. FIG. 4 illustrates a Bayesian quickest change detection methodology, though other methods for detecting anomalous performance are also contemplated within the scope of the disclosure.

The example method shown in FIG. 4 includes storing 404 historical performance signal data representing the historical performance level. In some embodiments, the anomaly detection component 104 maintains historical performance data (e.g., in the form of percentile values for latency data) that can be compared to performance signals being received from one or more workloads. The example method shown in FIG. 4 also includes assigning 406 a prior probability of the one or more production workloads exhibiting a particular performance level that is represented by the one or more performance signals, wherein the particular performance level is an anomalous performance level. Assigning 406 the prior probability can include determining the probability of a particular performance level indicating anomalous performance before performance signals are received that actually indicate anomalous performance. For example, based on historical performance signal data, anomaly detection component 104 can determine the probability of a performance level occurring that corresponds to anomalous performance.

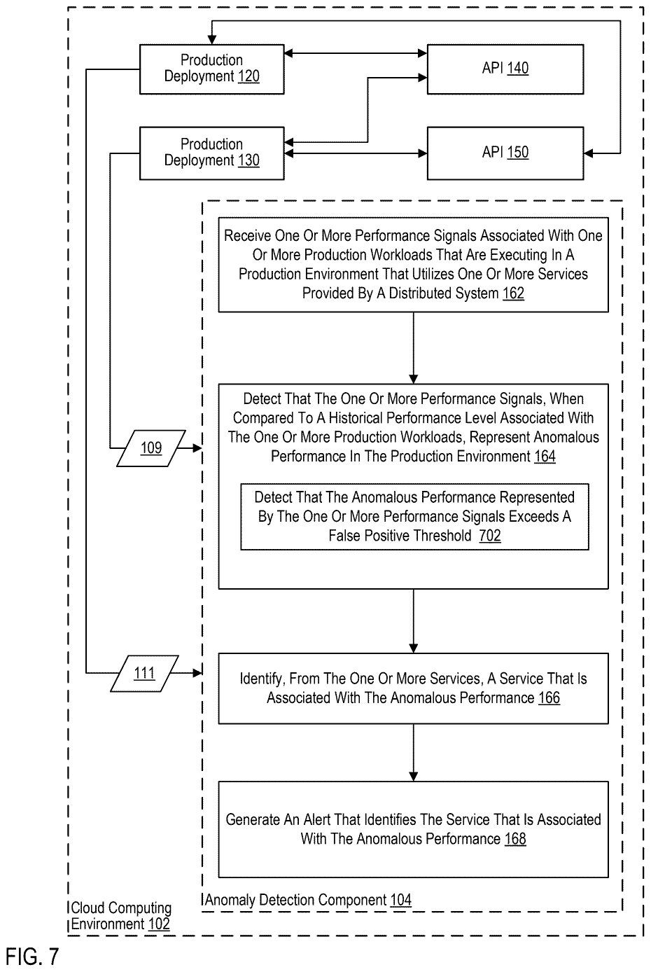

The example method shown in FIG. 4 also includes determining 408 a posterior probability of the particular performance level being reached, based on the one or more performance signals. For example, based on historical performance signal data and performance values received via the one or more performance signals, anomaly detection component 104 can determine the probability of a performance level occurring that corresponds to anomalous performance. In some embodiments, the posterior probability can be determined by updating the prior probability using the performance values received via the one or more performance signals. The example method shown in FIG. 4 also includes determining 410 that the posterior probability satisfies a threshold. Anomaly detection component 104 can define, for example, a threshold level beyond which a service may indicate anomalous performance. In some cases, the threshold may be set based on a false positive or false alarm rate that is defined for a customer workload. The anomaly detection component 104 can account for the occurrence of false positives when using the quickest change detection algorithm, as described in greater detail below with respect to FIG. 7.

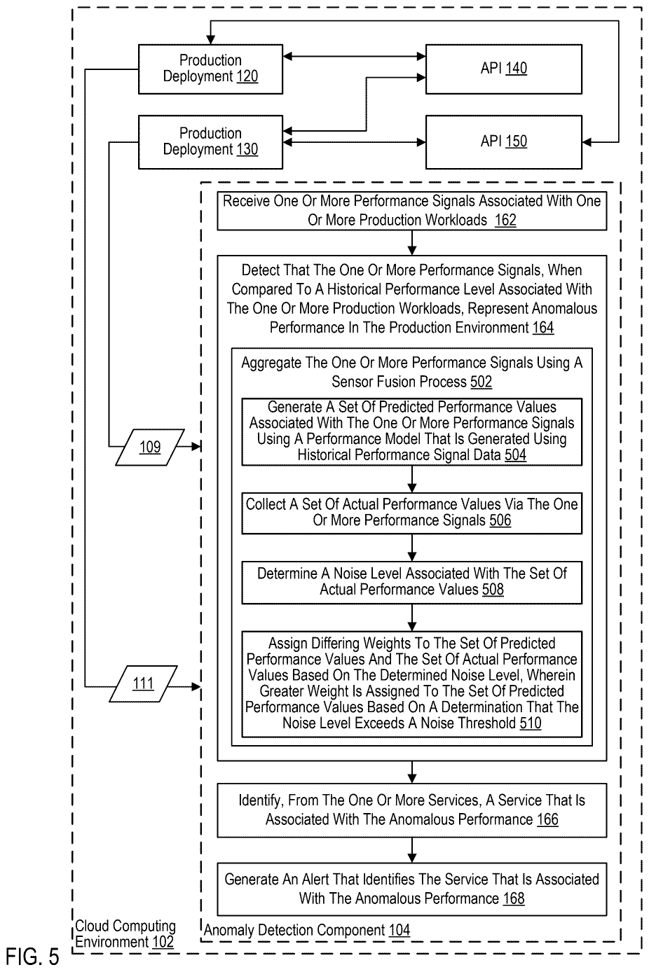

For further explanation, FIG. 5 sets forth a flow chart illustrating an example method for detecting performance anomalies affecting production workloads in accordance with some embodiments. The example method of FIG. 5 also includes aggregating 502 the one or more performance signals using a sensor fusion process. A sensor fusion process can be used to combine data from different sources to reduce noise or uncertainty so that the resulting signal is a stronger indicator of some outcome (e.g., a performance regression). The anomaly detection component 104 can use, for example, telemetry 109, 111 data as performance signal data associated with workloads 122, 124, 126, 132, 134, or 136. The anomaly detection component 104 can combine the data for one or more of the different performance signals using sensor fusion.

The telemetry 109, 111 data can include many different performance signals that indicate varying levels of performance that are changing over time. The telemetry 109, 111 data can, for example, indicate transient performance degradation events that exceed one or more thresholds where such events result in no meaningful or noticeable effect on a workload's performance. The events result may result in no meaningful or noticeable effect on a workload's performance, for example, because the transient performance degradation event was so brief that it did not impact a customer's experience or because the event did not impact operations of some other component. In some embodiments, the anomaly detection component 104 may be configured to treat such transient performance degradation events as noise that can be filtered out of the performance signals that are used to identify performance regression problems. In some embodiments, the sensor fusion process that is used by the anomaly detection component 104 may be configured to perform such filtering, including while aggregating the performance signals into an aggregate performance signal.

As depicted in FIG. 5, aggregating 502 the one or more performance signals using a sensor fusion process can include generating 504 a set of predicted performance values associated with the one or more performance signals using a performance model that is generated using historical performance signal data. Generating a set of predicted performance values can be carried out by anomaly detection component 104 providing historical performance signal data as input into a sensor fusion-based model such as a Kalman filter that can predict a next state for performance of a service or component.

The example method of FIG. 5 also includes collecting 506 a set of actual performance values via the one or more performance signals received by anomaly detection component 104. The actual performance values are also provided to the sensor fusion model which, in some embodiments, corrects the prediction based on a noise level associated with the actual performance values. Accordingly, the example method of FIG. 5 also includes determining 508 a noise level associated with the set of actual performance values. Determining the noise level can include determining a statistic associated with the set of actual performance values that can indicate a noise level, such as a noise covariance of the set of actual performance values. With each newly received signal, the prediction of the performance level can be refined, progressively reducing the effect of noise.

The example method of FIG. 5 also includes assigning 510 differing weights to the set of predicted performance values and the set of actual performance values based on the determined noise level, wherein greater weight is assigned to the set of predicted performance values based on a determination that the noise level exceeds a noise threshold. In some embodiments, if the set of actual performance values indicates a level of noise that exceeds a threshold, data from the actual performance values is integrated into the sensor fusion model but less weight is accorded to the actual performance values compared to an instance where the actual performance values exhibit noise levels below a threshold.

The anomaly detection component 104 can also use sensor fusion to amplify one or more performance signals in order to more quickly identify performance regression events in other ways. Consider an example where a performance signal (e.g., a signal showing increased latency) may be a relatively weak signal. For example, anomaly detection component 104 may receive, from a set of workloads, multiple performance signals indicating latency that is at 4-6% higher than normal for each of the set of workloads for approximately 4-6 seconds, with one other workload outside the set indicating latency that is 90% higher than normal that lasted for 1 second. In this example, the anomaly detection component 104 can aggregate all of the received performance signals to generate an aggregate performance signal. In some embodiments, however, the anomaly detection component 104 can filter out the one workload indicating 90% higher than normal latency from the aggregate performance signal. Such data may be filtered, for example, based on a determination that this latency event occurred for a time period that was too brief to register as a latency event requiring remediation and thus considered noise that can be smoothed out of the aggregate performance signal. In some embodiments, the anomaly detection component 104 can determine that the aggregated performance signal satisfies an aggregate performance degradation threshold. For example, the aggregate performance degradation threshold can be defined as a combination of factors, such as a level of deviation from an expected level, a time that the deviation lasts, a number of workloads that are showing the deviation, or other factors.

Readers will appreciate that the aggregation of signals may be customized in various ways. For example, as described above, there may be customers of a cloud service provider that are external to the organization that implements the cloud service or services that are part of cloud computing environment 102. Other customers of cloud computing environment 102 may be internal, as in internal customers that may be part of the same organization that offers cloud computing environment 102. In some cases, a cloud service provider may consider performance issues occurring with respect to an external customer's workload to be of higher priority relative to issues at an internal customer's workload. Based on such considerations, anomaly detection component 104 can be configured to assign higher weight to performance signals that are associated with external customer workloads relative to other performance signals associated with internal customer workloads, when generating the aggregated performance signal. In some embodiments, the anomaly detection component 104 compares the aggregated performance signal to a performance degradation threshold and, based on the comparison, determines whether to identify that a latency regression is occurring across one or more customer workloads.

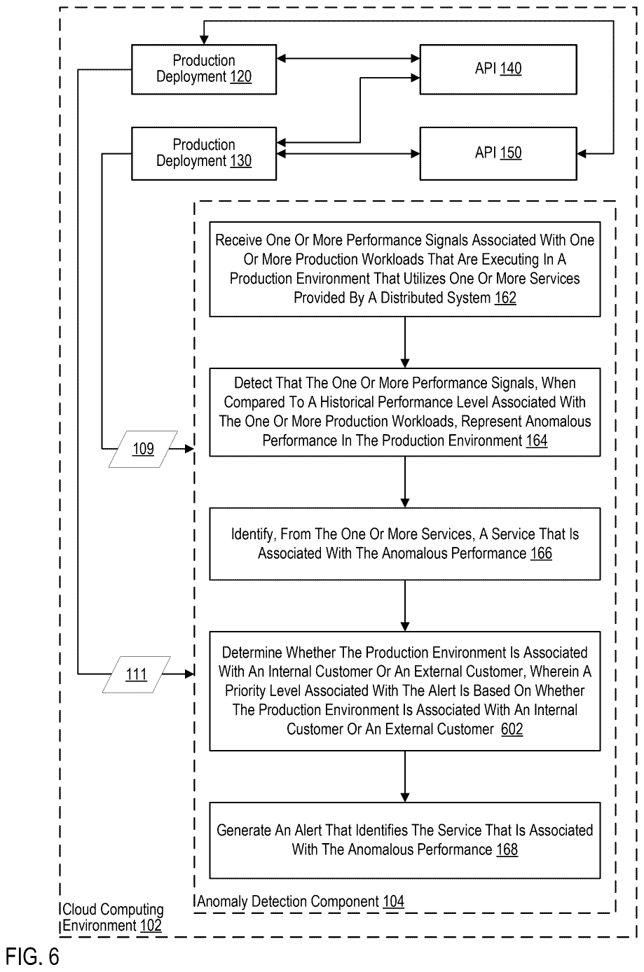

For further explanation, FIG. 6 sets forth a flow chart illustrating an example method for detecting performance anomalies affecting production workloads in accordance with some embodiments. The example method depicted in FIG. 6 includes determining 602 whether the production environment is associated with an internal customer or an external customer. As discussed above, an internal customer may include customers that are part of the business organization that operates as the cloud service provider. Internal customers may include, for example, internal engineering teams, internal corporate teams, internal testing teams, and so on. The internal customers, generally speaking, may not be paying customers that the cloud service provider generates revenue from having in its customer base. External customers may include more traditional customers who are part of a different business organization than the cloud service provider, where these external customers are often revenue generating customers from the perspective of the cloud service provider. In FIG. 6, a priority level associated with the alert is based on whether the production environment is associated with an internal customer or an external customer. For example, alerts that are associated with some performance degradation to an internal customer's production environment may have a lower priority than alerts that are associated with some performance degradation to an external customer's production environment.

For further explanation, FIG. 7 sets forth a flow chart illustrating an example method for detecting performance anomalies affecting production workloads in accordance with some embodiments. The example method of FIG. 7 includes detecting 702 that the anomalous performance represented by the one or more performance signals exceeds a false positive threshold. In some embodiments, the anomaly detection component 104 can define a false positive threshold at an individual customer level, workload level, service level, or in other ways. For a performance signal associated with a workload, the anomaly detection component 104 can define a detection delay that is optimized based on the specific false positive threshold for that workload (or for that customer).

In some embodiments, the false positive threshold may be defined as a false positive rate threshold. A false positive rate threshold can be, for example, a number between 0 and 1. A determination that a performance anomaly is occurring for a workload may be delayed until the false positive rate threshold is satisfied. The false positive rate threshold can define an acceptable rate or target value at which events such as service executions having performance values indicative of a performance anomaly (e.g., latency readings exceeding acceptable levels) for a workload can occur without triggering a determination that a performance anomaly is occurring for that workload. The false positive rate threshold can be set at, for example, 0.01 (or 1%), meaning that 1% of the events.

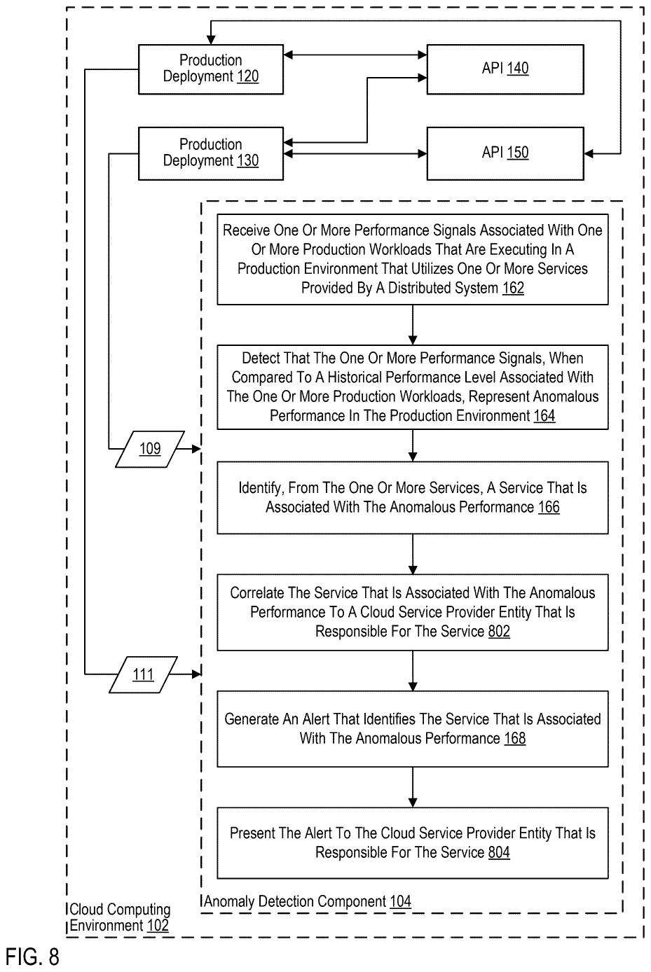

For further explanation, FIG. 8 sets forth a flow chart illustrating an example method for detecting performance anomalies affecting production workloads in accordance with some embodiments. The example method of FIG. 8 includes correlating 802, using an execution record identifying the service, the service that is associated with the anomalous performance to a cloud service provider entity that is responsible for the service. Referring back to FIG. 3, the anomaly detection component 104 can identify a critical path of service executions from an execution record that is generated using performance samples for one or more services in order to identify a specific service (or services) that is likely responsible for a performance regression event. The anomaly detection component 104 can access information, such as profile information or configuration information for the identified service that lists an administrator, engineer, technician, or team of relevant professionals that are responsible for operations of an API, a service, or a feature or facility provided by cloud computing environment 102. Such information may be maintained, for example, by a resource management service for the cloud service provider, specified when creating a particular production deployment, or established in some other way. By using such information, the anomaly detection component 104 can identify one or more individuals or groups that maintain services that are associated with some performance anomaly.

In some embodiments, the anomaly detection component 104 can also determine a budget or allocation for service responsibility as it relates to a performance anomaly. The responsibility can be allocated in different ways, such as at an individual level or team level, or it can also be associated with a particular system, a set of devices, or in other ways. It will be appreciated that different services may be involved in servicing a workload at different points in time, and there may be involvement of different services at different times during a performance anomaly that is identified for a workload. Moreover, one service may be implicated at different times during the performance anomaly. Accordingly, the anomaly detection component 104 can determine the proportion of time or severity of the performance anomaly that was allocatable to a particular service and allocate a corresponding proportion of responsibility to one or more individuals that internally manage the service within cloud computing environment 102.

The example depicted in FIG. 8 also includes presenting 804 the alert to the cloud service provider entity that is responsible for the service. Presenting 804 the alert to the cloud service provider entity that is responsible for the service can be carried out, for example, by sending a notification to one or more entities or generating an incident ticket that captures the performance regression event that is occurring. The incident ticket can include details of the specific workload(s), device(s), service(s), or other components that are associated with the performance regression. The anomaly detection component 104 can be configured to automatically assign the incident ticket to the relevant individuals or teams, such as those that were correlated as described above to the service(s) identified as being involved in the performance regression. In some embodiments, the affected customer(s) may also be notified via the ticket or in other ways.

While the above description details scenarios where the performance regression originates from a component provided by cloud computing environment 102, such as a service exposed by an API of cloud computing environment 102, the disclosed systems can also be employed to identify sources of performance regression that originate from customer workloads, customer software, customer devices, or other customer-owned components. In some embodiments, the anomaly detection component 104 can receive telemetry data from other devices that are connected to cloud computing environment 102 and use this received telemetry data to isolate sources of performance regression impacting cloud computing environment 102. In other embodiments, the anomaly detection component 104 can identify that the performance regression is not due to an issue with a service of cloud computing environment 102 but instead is due to a misconfiguration or other error generated from the customer side. In such cases, the anomaly detection component 104 can provide alerts similar to those discussed above that identify the root cause of the performance regression and provide suggested remediation steps.

Furthermore, anomaly detection component 104 can use one or more artificial intelligence or machine learning models such as a large language model (LLM) interface to help detect performance regressions, diagnose the source of the regression, and/or identify solutions. As referred to herein, an LLM interface can be an interface for accepting queries from anomaly detection component 104. Although the discussion is presented in the context of an LLM, readers will appreciate that the approaches set forth herein may also be applied to other types of generative artificial intelligence (AI) models, machine learning models, and the like.

As referred to herein, generative AI uses models such as neural networks, including large language models (LLMs) including proprietary models such as ChatGPT or open-source models such as Llama, large multimodal models (LMMs) such as Gemini or DALL-E, and the like to generate content, such as text, code, graphics, animations, video, audiovisual representations, audio, speech, etc., in response to prompts. The generative AI models are trained using a corpus of training data content to learn the patterns and structure of that content. The generative AI model may then generate new content having the characteristics learned from the training data. Prompts may include text, code, audio, graphic, video, and representations in any other media. Such prompts may be provided to the generative AI model as a natural language input. For example, the approaches set forth herein may interact with a generative AI model using predefined prompts, dynamically generated prompts, prompts that include some portion of dynamically generated content (e.g., through the use of templates and dynamically populated variables), and the like.

Accordingly, the anomaly detection component 104 can be configured to train an AI or ML model such as an LLM using performance signal data, workload data, customer data, API or service data, and related information from cloud computing environment 102. Based on the training, the LLM can receive a query, such as a workload identifier and performance regression information, and issue an output such as a likely source of the regression (e.g., a specific service) or one or more remediation steps that are likely to resolve the performance regression event.

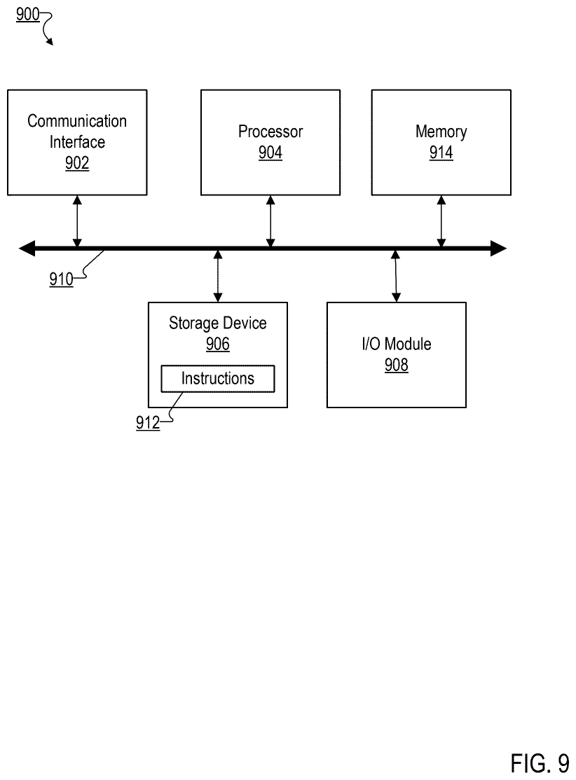

For further explanation, the sections included below provide some details regarding technologies that may be used to support detecting performance anomalies affecting production workloads. For example, FIG. 9 sets forth an example of a computing device that may be used for some portion of detecting performance anomalies affecting production workloads in accordance with some embodiments. As an additional example of technologies that may be used to support accelerating queries, FIG. 10 sets forth a block diagram of a cloud services provider service architecture in accordance with some embodiments of the present disclosure.

For further explanation, FIG. 9 illustrates an exemplary computing device 900 that may be specifically configured to perform one or more of the processes described herein. As shown in FIG. 9, computing device 900 may include a communication interface 902, a processor 904, a storage device 906, an input/output (I/O) module 908, and computer memory 914 communicatively connected one to another via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data and/or interpreting, executing, and/or directing execution of one or more of the instructions, processes, and/or operations described herein. Processor 904 may perform operations by executing computer-executable instructions 912 (e.g., an application, software, code, and/or other executable data instance) stored in storage device 906.

Storage device 906 may include one or more data storage media, devices, or configurations and may employ any type, form, and combination of data storage media and/or device. For example, storage device 906 may include, but is not limited to, any combination of non-volatile media and/or volatile media. Electronic data, including data described herein, may be temporarily and/or permanently stored in storage device 906. For example, data representative of computer-executable instructions 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 900.

For further explanation and as an additional example of a supporting technology for detecting performance anomalies affecting production workloads, FIG. 10 sets forth a block diagram of a cloud services provider service architecture in accordance with some embodiments. The cloud services provider 1002 can deliver a variety resources through a services-based consumption model where resources are consumed on-demand and as-a-service by, for example, client 1032 via network 1034.

FIG. 10 depicts an embodiment where software 1020 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 10, as examples of software 1020 that can be delivered as-a-service, the illustrated embodiment includes office productivity 1022 software, customer relationship management (‘CRM’) 1024 software, and project management 1026 software. The office productivity 1022 software can include applications designed to facilitate common business and personal tasks, including word processing applications, applications for spreadsheet creation, presentation design applications, and many others. The CRM 1024 software can include applications for managing a business organization's relationships and interactions with customers and potential customers. The project management 1026 software can include applications designed to help teams plan, organize, and manage projects efficiently by facilitating collaboration and tracking the progress of projects. Readers will appreciate that in other embodiments, other types of software may be delivered using a SaaS model.

FIG. 10 depicts an embodiment where platforms 1012 can be delivered as a service. Platform-as-a-service (‘PaaS’) is a model that provides cloud customers with platform resources that they can use to develop, run, and manage applications without the complexity of such deploying and managing such infrastructure on their own. In FIG. 10, as examples of platform 1012 resources that can be delivered as-a-service, the illustrated embodiment includes database 1014 services, development tools 1016 services, and execution runtime 1018 services. The database 1014 services can be used to provide access to databases without management overhead for the user as the cloud services provider manages the provisioning, scaling, and maintenance of the databases. The development tools 1016 services can provide developers with tools to design, develop, test, and deploy applications without needing to manage the underlying infrastructure. The execution runtime 1018 services can provide environments where applications or other forms of computer program code can be executed, including services to scale the execution environment. Readers will appreciate that in other embodiments, other platform resources may be delivered using a PaaS model.

FIG. 10 depicts an embodiment where infrastructure 1004 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 10, as examples of infrastructure 1004 resources that can be delivered as-a-service, the illustrated embodiment includes compute 1006 services, storage 1008 services, and networking 1010 services. The compute 1006 services can be used to provide on-demand access to computational resources such as VMs, containers, and serverless functions, where the cloud services provider manages the provisioning, scaling, and maintenance of such resources. The storage 1008 services can provide storage resources that can be used to store and access data, without the need for customers to purchase and manage on-premises physical storage resources. The networking 1010 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud services provider of FIG. 10 also provides management 1030 resources. The management 1030 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud services provider of FIG. 10 also provides security 1028 resources. The security 1028 resources can include, for example, tools and services to help customers protect their cloud environments and ensure compliance with security standards. These tools and services may provide specific aspects of security, including identity and access management, network security, threat detection, compliance management, and others.

Advantages and features of the present disclosure can be further described by the following statements:
1. A method comprising: receiving one or more performance signals associated with one or more production workloads that are executing in a production environment that utilizes one or more services provided by a distributed system; detecting that the one or more performance signals, when compared to a historical performance level associated with the one or more production workloads, represent anomalous performance in the production environment; identifying, from the one or more services, a service that is associated with the anomalous performance; and generating an alert that identifies the service that is associated with the anomalous performance.
2. The method of any combination of one or more of the statements above, wherein the distributed system is a cloud computing environment created by a cloud service provider, the method further comprising: correlating, using an execution record identifying the service, the service that is associated with the anomalous performance to a cloud service provider entity that is responsible for the service; and presenting the alert to the cloud service provider entity that is responsible for the service.
3. The method of any combination of one or more of the statements above, further comprising: determining that the one or more performance signals deviate from a respective historical performance level; and based on the determination that the one or more performance signals deviate from the respective historical performance level, comparing an aggregate of the one or more performance signals to an aggregate performance degradation threshold.
4. The method of any combination of one or more of the statements above, further comprising: obtaining a plurality of performance samples associated with the one or more services provided by the distributed system, wherein the plurality of performance samples includes: a first set of samples representing expected performance levels associated with the one or more services, and a second set of performance representing unexpected performance levels associated with the one or more services; and identifying the service using an execution record for the one or more services that is generated from the plurality of performance samples.
5. The method of any combination of one or more of the statements above, wherein detecting that the one or more performance signals, when compared to a historical performance level associated with the one or more production workloads, represent anomalous performance in the production environment further comprises using a quickest change detection algorithm, including: storing historical performance signal data representing the historical performance level; assigning a prior probability of the one or more production workloads exhibiting a particular performance level that is represented by the one or more performance signals, wherein the particular performance level is an anomalous performance level; determining a posterior probability of the particular performance level being reached, based on the one or more performance signals; and determining that the posterior probability satisfies a threshold.
6. The method of any combination of one or more of the statements above, further comprising aggregating the one or more performance signals using a sensor fusion process, including: generating a set of predicted performance values associated with the one or more performance signals using a performance model that is generated using historical performance signal data; collecting a set of actual performance values via the one or more performance signals; determining a noise level associated with the set of actual performance values; and assigning differing weights to the set of predicted performance values and the set of actual performance values based on the determined noise level, wherein greater weight is assigned to the set of predicted performance values based on a determination that the noise level exceeds a noise threshold.
7. The method of any combination of one or more of the statements above, further comprising detecting that the anomalous performance represented by the one or more performance signals exceeds a false positive threshold.
8. The method of any combination of one or more of the statements above, further comprising determining whether the production environment is associated with an internal customer or an external customer, wherein a priority level associated with the alert is based on whether the production environment is associated with an internal customer or an external customer.
9. An apparatus for detecting performance anomalies affecting production workloads, comprising: a memory; and one or more processing devices, operatively coupled to the memory, the one or more processing devices configured to: receive one or more performance signals associated with one or more production workloads that are executing in a production environment that utilizes one or more services provided by a distributed system; detect that the one or more performance signals, when compared to a historical performance level associated with the one or more production workloads, represent anomalous performance in the production environment; identify, from the one or more services, a service that is associated with the anomalous performance; and generate an alert that identifies the service that is associated with the anomalous performance.
10. The apparatus of any combination of one or more of the statements above, wherein the distributed system is a cloud computing environment created by a cloud service provider and the one or more processing devices are further configured to: correlate the service that is associated with the anomalous performance to a cloud service provider entity that is responsible for the service; and present the alert to the cloud service provider entity that is responsible for the service.
11. The apparatus of any combination of one or more of the statements above, wherein the one or more processing devices are further configured to: determine that the one or more performance signals deviate from a respective historical performance level; and compare an aggregate of the one or more performance signals to an aggregate performance degradation threshold.
12. The apparatus of any combination of one or more of the statements above, wherein the one or more processing devices are further configured to: obtain a plurality of performance samples associated with the one or more services provided by the distributed system, wherein the plurality of performance samples includes: a first set of samples representing expected performance levels associated with the one or more services, and a second set of performance representing unexpected performance levels associated with the one or more services; and identify the service using an execution record for the one or more services that is generated from the plurality of performance samples.
13. The apparatus of any combination of one or more of the statements above, wherein detecting that the one or more performance signals, when compared to a historical performance level associated with the one or more production workloads, represent anomalous performance in the production environment further comprises using a quickest change detection algorithm, including: storing historical performance signal data representing the historical performance level; assigning a prior probability of the one or more production workloads exhibiting a particular performance level that is represented by the one or more performance signals, wherein the particular performance level is an anomalous performance level; determining a posterior probability of the particular performance level being reached, based on the one or more performance signals; and determining that the posterior probability satisfies a threshold.
14. The apparatus of any combination of one or more of the statements above, wherein the one or more processing devices are further configured to aggregate the one or more performance signals using a sensor fusion process, including: generating a set of predicted performance values associated with the one or more performance signals using a performance model that is generated using historical performance signal data; collecting a set of actual performance values via the one or more performance signals; determining a noise level associated with the set of actual performance values; and assigning differing weights to the set of predicted performance values and the set of actual performance values based on the determined noise level, wherein greater weight is assigned to the set of predicted performance values based on a determination that the noise level exceeds a noise threshold.
15. The apparatus of any combination of one or more of the statements above, wherein the one or more processing devices are further configured to detect that the anomalous performance represented by the one or more performance signals exceeds a false positive threshold.
16. The apparatus of any combination of one or more of the statements above, wherein the one or more processing devices are further configured to determine whether the production environment is associated with an internal customer or an external customer, wherein a priority level associated with the alert is based on whether the production environment is associated with an internal customer or an external customer.
17. A non-transitory computer readable storage medium, wherein the distributed system is a cloud computing environment created by a cloud service provider, and the computer readable storage medium stores instructions which, when executed, cause a processing device to: receive one or more performance signals associated with one or more production workloads that are executing in a production environment that utilizes one or more services provided by a distributed system; detect that the one or more performance signals, when compared to a historical performance level associated with the one or more production workloads, represent anomalous performance in the production environment; identify, from the one or more services, a service that is associated with the anomalous performance; and generate an alert that identifies the service that is associated with the anomalous performance.
18. The non-transitory computer readable storage medium of any combination of one or more of the statements above, wherein the instructions, when executed, further cause the processing device to: correlate the service that is associated with the anomalous performance to a cloud service provider entity that is responsible for the service; and present the alert to the cloud service provider entity that is responsible for the service.
19. The non-transitory computer readable storage medium of any combination of one or more of the statements above, wherein the instructions, when executed, further cause the processing device to: determine that the one or more performance signals deviate from a respective historical performance level; and compare an aggregate of the one or more performance signals to an aggregate performance degradation threshold.
20. The non-transitory computer readable storage medium of any combination of one or more of the statements above, wherein the instructions, when executed, further cause a processing device to: obtain a plurality of performance samples associated with the one or more services provided by the distributed system, wherein the plurality of performance samples includes: a first set of samples representing expected performance levels associated with the one or more services, and a second set of performance representing unexpected performance levels associated with the one or more services; and identify the service using an execution record for the one or more services that is generated from the plurality of performance samples.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method comprising:
receiving one or more performance signals associated with one or more production workloads that are executing in a production environment that utilizes one or more services provided by a distributed system;
detecting that the one or more performance signals, when compared to a historical performance level associated with the one or more production workloads, represent anomalous performance in the production environment;
identifying, from the one or more services, a service that is associated with the anomalous performance; and
generating an alert that identifies the service that is associated with the anomalous performance.

2. The method of claim 1 wherein the distributed system is a cloud computing environment created by a cloud service provider, the method further comprising:
correlating, using an execution record identifying the service, the service that is associated with the anomalous performance to a cloud service provider entity that is responsible for the service; and
presenting the alert to the cloud service provider entity that is responsible for the service.

3. The method of claim 1, further comprising:
determining that the one or more performance signals deviate from a respective historical performance level; and
based on the determination that the one or more performance signals deviate from the respective historical performance level, comparing an aggregate of the one or more performance signals to an aggregate performance degradation threshold.

4. The method of claim 1, further comprising:
obtaining a plurality of performance samples associated with the one or more services provided by the distributed system, wherein the plurality of performance samples includes:
a first set of samples representing expected performance levels associated with the one or more services, and
a second set of performance representing unexpected performance levels associated with the one or more services; and
identifying the service using an execution record for the one or more services that is generated from the plurality of performance samples.

5. The method of claim 1, wherein detecting that the one or more performance signals, when compared to a historical performance level associated with the one or more production workloads, represent anomalous performance in the production environment further comprises using a quickest change detection algorithm, wherein using the quickest change detection algorithm further comprises:
storing historical performance signal data representing the historical performance level;
assigning a prior probability of the one or more production workloads exhibiting a particular performance level that is represented by the one or more performance signals, wherein the particular performance level is an anomalous performance level;
determining a posterior probability of the particular performance level being reached, based on the one or more performance signals; and
determining that the posterior probability satisfies a threshold.

6. The method of claim 1, further comprising aggregating the one or more performance signals using a sensor fusion process, wherein using the sensor fusion process further comprises:
generating a set of predicted performance values associated with the one or more performance signals using a performance model that is generated using historical performance signal data;
collecting a set of actual performance values via the one or more performance signals;
determining a noise level associated with the set of actual performance values; and
assigning differing weights to the set of predicted performance values and the set of actual performance values based on the determined noise level, wherein greater weight is assigned to the set of predicted performance values based on a determination that the noise level exceeds a noise threshold.

7. The method of claim 1, further comprising detecting that the anomalous performance represented by the one or more performance signals exceeds a false positive threshold.

8. The method of claim 1, further comprising determining whether the production environment is associated with an internal customer or an external customer, wherein a priority level associated with the alert is based on whether the production environment is associated with an internal customer or an external customer.

9. An apparatus for detecting performance anomalies affecting production workloads, comprising:
a memory; and
one or more processing devices, operatively coupled to the memory, the one or more processing devices configured to:
receive one or more performance signals associated with one or more production workloads that are executing in a production environment that utilizes one or more services provided by a distributed system;
detect that the one or more performance signals, when compared to a historical performance level associated with the one or more production workloads, represent anomalous performance in the production environment;
identify, from the one or more services, a service that is associated with the anomalous performance; and
generate an alert that identifies the service that is associated with the anomalous performance.

10. The apparatus of claim 9, wherein the distributed system is a cloud computing environment created by a cloud service provider and the one or more processing devices are further configured to:
correlate the service that is associated with the anomalous performance to a cloud service provider entity that is responsible for the service; and
present the alert to the cloud service provider entity that is responsible for the service.

11. The apparatus of claim 9, wherein the one or more processing devices are further configured to:
determine that the one or more performance signals deviate from a respective historical performance level; and
compare an aggregate of the one or more performance signals to an aggregate performance degradation threshold.

12. The apparatus of claim 9, wherein the one or more processing devices are further configured to:
obtain a plurality of performance samples associated with the one or more services provided by the distributed system, wherein the plurality of performance samples includes:
a first set of samples representing expected performance levels associated with the one or more services, and
a second set of performance representing unexpected performance levels associated with the one or more services; and
identify the service using an execution record for the one or more services that is generated from the plurality of performance samples.

13. The apparatus of claim 9, wherein detecting that the one or more performance signals, when compared to a historical performance level associated with the one or more production workloads, represent anomalous performance in the production environment further comprises using a quickest change detection algorithm, wherein using a quickest change detection algorithm further comprises:
storing historical performance signal data representing the historical performance level;
assigning a prior probability of the one or more production workloads exhibiting a particular performance level that is represented by the one or more performance signals, wherein the particular performance level is an anomalous performance level;
determining a posterior probability of the particular performance level being reached, based on the one or more performance signals; and
determining that the posterior probability satisfies a threshold.

14. The apparatus of claim 9, wherein the one or more processing devices are further configured to aggregate the one or more performance signals using a sensor fusion process, wherein using sensor fusion process further comprises:
generating a set of predicted performance values associated with the one or more performance signals using a performance model that is generated using historical performance signal data;
collecting a set of actual performance values via the one or more performance signals;
determining a noise level associated with the set of actual performance values; and
assigning differing weights to the set of predicted performance values and the set of actual performance values based on the determined noise level, wherein greater weight is assigned to the set of predicted performance values based on a determination that the noise level exceeds a noise threshold.

15. The apparatus of claim 9, wherein the one or more processing devices are further configured to detect that the anomalous performance represented by the one or more performance signals exceeds a false positive threshold.

16. The apparatus of claim 9, wherein the one or more processing devices are further configured to determine whether the production environment is associated with an internal customer or an external customer, wherein a priority level associated with the alert is based on whether the production environment is associated with an internal customer or an external customer.

17. A non-transitory computer readable storage medium, wherein a distributed system is a cloud computing environment created by a cloud service provider, and the non-transitory computer readable storage medium stores instructions which, when executed, cause a processing device to:
receive one or more performance signals associated with one or more production workloads that are executing in a production environment that utilizes one or more services provided by a distributed system;
detect that the one or more performance signals, when compared to a historical performance level associated with the one or more production workloads, represent anomalous performance in the production environment;
identify, from the one or more services, a service that is associated with the anomalous performance; and
generate an alert that identifies the service that is associated with the anomalous performance.

18. The non-transitory computer readable storage medium of claim 17 wherein the instructions, when executed, further cause the processing device to:
correlate the service that is associated with the anomalous performance to a cloud service provider entity that is responsible for the service; and
present the alert to the cloud service provider entity that is responsible for the service.

19. The non-transitory computer readable storage medium of claim 17 wherein the instructions, when executed, further cause the processing device to:
determine that the one or more performance signals deviate from a respective historical performance level; and
compare an aggregate of the one or more performance signals to an aggregate performance degradation threshold.

20. The non-transitory computer readable storage medium of claim 17 wherein the instructions, when executed, further cause a processing device to:
obtain a plurality of performance samples associated with the one or more services provided by the distributed system, wherein the plurality of performance samples includes:
a first set of samples representing expected performance levels associated with the one or more services, and
a second set of performance representing unexpected performance levels associated with the one or more services; and
identify the service using an execution record for the one or more services that is generated from the plurality of performance samples.
